(19) United States
(12) Patent Application Publication
(10) Pub. No.: US 2023/0220940 A1
(43) Pub. Date: Jul. 13, 2023

(54) DISK WITH ADJUSTABLE OUTER DIAMETER

(71) Applicant: Inventions, Plus LLC, Springfield, OR (US)

(72) Inventors: Arthur Wells, Millersburg, OR (US); Kyle McGann, Warren, OR (US); John Parmigiani, Eugene, OR (US)

(73) Assignee: Inventions, Plus LLC, Springfield, OR (US)

(21) Appl. No.: 17/571,438

(22) Filed: Jan. 7, 2022

(51) Int. Cl. F16L 55/136; F16L 55/128

(52) U.S. Cl. CPC F16L 55/136; F16L 55/1286

(57) ABSTRACT

An apparatus includes a hub and multiple thin, flat, deformable panels. Each panel is a trapezoid with parallel base and top. The panels are foldably connected together base-to-top to form a closed ring. A proximal end portion side of each panel is attached the hub. A proximal portion of each panel is wound around the hub; a distal portion of each panel extends tangentially away from the hub. Proximal portions of each panel winding around the hub decreases an apparatus outer diameter; proximal portions of each panel unwinding from around the hub increases the apparatus outer diameter.

### FIELD OF THE INVENTION

The field of the present invention relates to mechanical members with adjustable sizes. In particular, a disk with an adjustable outer diameter is disclosed.

### SUMMARY

An inventive apparatus comprises a round hub and a plurality of thin, flat, deformable panels. The round hub is characterized by a hub outer diameter D_{H}. Each panel has the shape of a trapezoid with a base, a top parallel to the base, a proximal side, and a distal side. The panels are foldably connected together base-to-top to form a closed ring. A proximal end portion of each panel is attached to an outer circumferential surface of the hub. A proximal portion of each panel is wound around the hub and a distal portion of each panel extends tangentially away from the hub. The apparatus moves between a retracted arrangement and an expanded arrangement; the apparatus can assume arrangements between those extremes. Length of the proximal portion of each panel that is wound around the hub varies between a maximum wound length in the retracted arrangement and a minimum wound length in the expanded arrangement, so that an apparatus outer diameter D_{A} across the hub and panels can vary between a minimum diameter D_{R} in the retracted arrangement and a maximum diameter D_{E} in the expanded arrangement; D_{A} can assume values between those extremes. In some examples an actuator mechanism can be operatively coupled to the hub and the panels so as to move the apparatus between the retracted and expanded arrangements.

In some instances an inventive apparatus can be used as an adjustable-diameter lid or cover for a container. In some instances an inventive apparatus can be used to block, seal, or occlude an opening, passage, or duct. In some examples an inventive apparatus can be employed as a radial spring. In some examples an inventive apparatus can be employed as a centering or alignment jig. An inventive apparatus can be employed for other uses requiring a disk with an adjustable outer diameter.

Objects and advantages pertaining to an adjustable-diameter disk may become apparent upon referring to the example embodiments illustrated in the drawings and disclosed in the following written description or appended claims.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A-1C are perspective, side, and top views of a set of panels of an example inventive apparatus; FIG. 1D is a top view of the set of panels after moving toward the retracted arrangement from the arrangement of FIGS. 1A-1C. FIGS. 1C and 1D include a hub.

FIG. 2 illustrates schematically the arrangement of one panel.

FIGS. 3A and 3B illustrate schematically forming of set of panels by folding a sheet.

FIGS. 4A-4E are top, side, bottom, lower isometric, and upper isometric views of an example of an actuator member rotatably engaged with the hub.

The embodiments depicted are shown only schematically; all features may not be shown in full detail or in proper proportion; for clarity certain features or structures may be exaggerated or diminished relative to others or omitted entirely; the drawings should not be regarded as being to scale unless explicitly indicated as being to scale. The embodiments shown are only examples and should not be construed as limiting the scope of the present disclosure or appended claims.

### DETAILED DESCRIPTION

The following detailed description should be read with reference to the drawings, in which identical reference numbers refer to like elements throughout the different figures. The drawings, which are not necessarily to scale, depict selective examples and are not intended to limit the scope of the inventive subject matter. The detailed description illustrates by way of example, not by way of limitation, the principles of the inventive subject matter.

An iris diaphragm is a well-known mechanical device with an adjustable diameter, specifically, the inner diameter of an opening or orifice. It would be desirable to provide a disk with an adjustable outer diameter. Such an adjustable-diameter disk could be employed in a number of different settings.

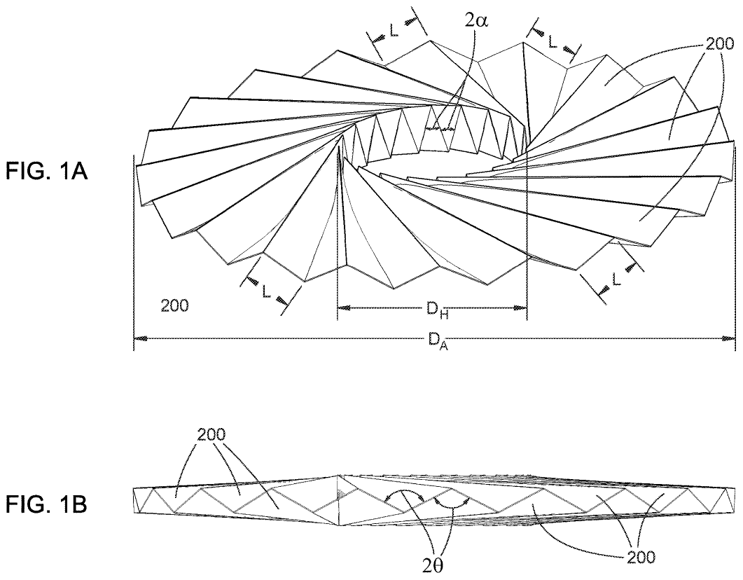

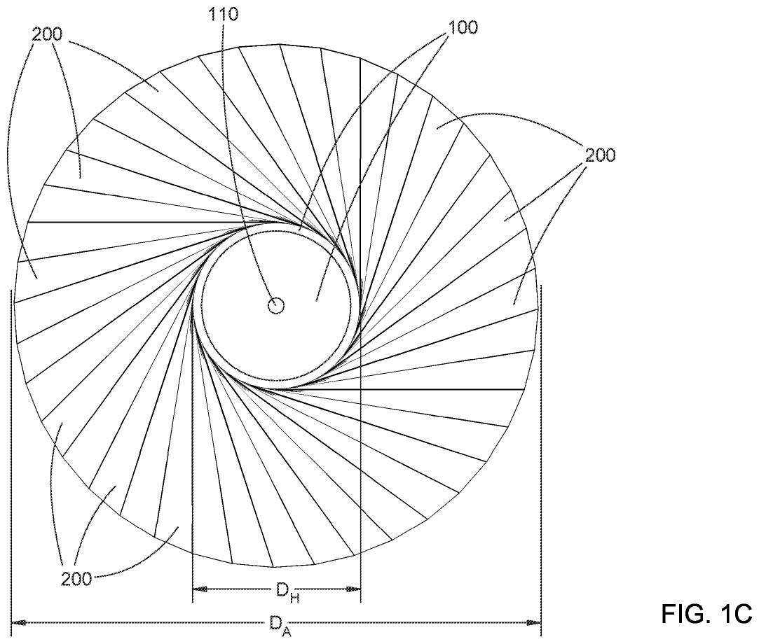

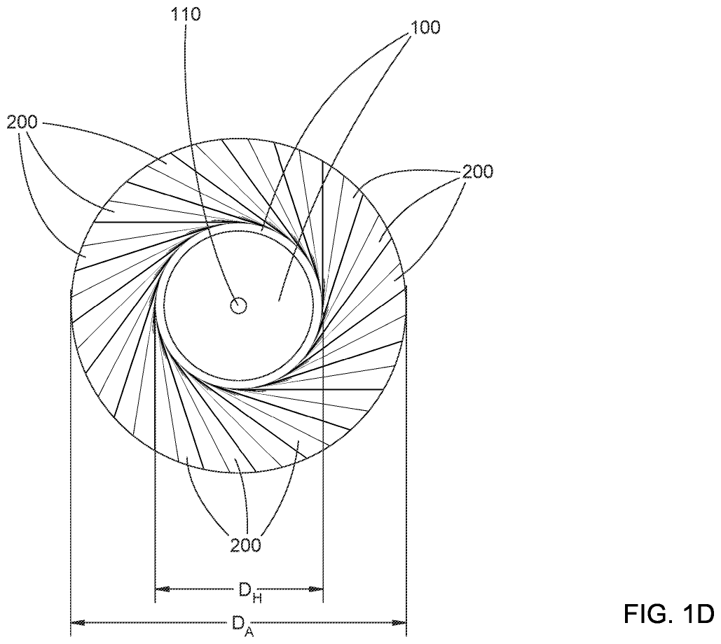

An inventive apparatus, in the form of a disk with an adjustable outer diameter, includes a round hub 100, a plurality of thin, flat, deformable panels 200, and an actuator mechanism. An example is shown (without the actuator mechanism) in FIGS. 1A-1D (and without the hub 100 in FIGS. 1A and 1B). The round hub 100 is characterized by a hub outer diameter D_{H}. Each panel 200 has the shape of a trapezoid with a base 201, a top 202 parallel to the base 201, a proximal side 203, and a distal side 204. Note that the inclusive definition of a trapezoid is being employed herein, i.e., a trapezoid is a quadrilateral with at least one pair (and in some instances two pairs) of parallel sides. In some examples each trapezoidal panel 200 has the shape of a parallelogram (e.g., as in FIG. 2) with a base 201 and a top 202 of length B, proximal and distal sides 203 and 204, respectively, of length L, and interior angles of 90°±α with 0°<α<90°. The panels 200 (trapezoids or parallelograms) are foldably connected together base-to-top (i.e., the base 201 of one panel 200 is connected to the top 202 of the next panel 200, and so on) to form a closed ring. A proximal end portion of each panel 200 is attached to an outer circumferential surface of the hub 100. A proximal portion of each panel 200 is wound around the hub 100; a distal portion of each panel 200 extends tangentially away from the hub 100.

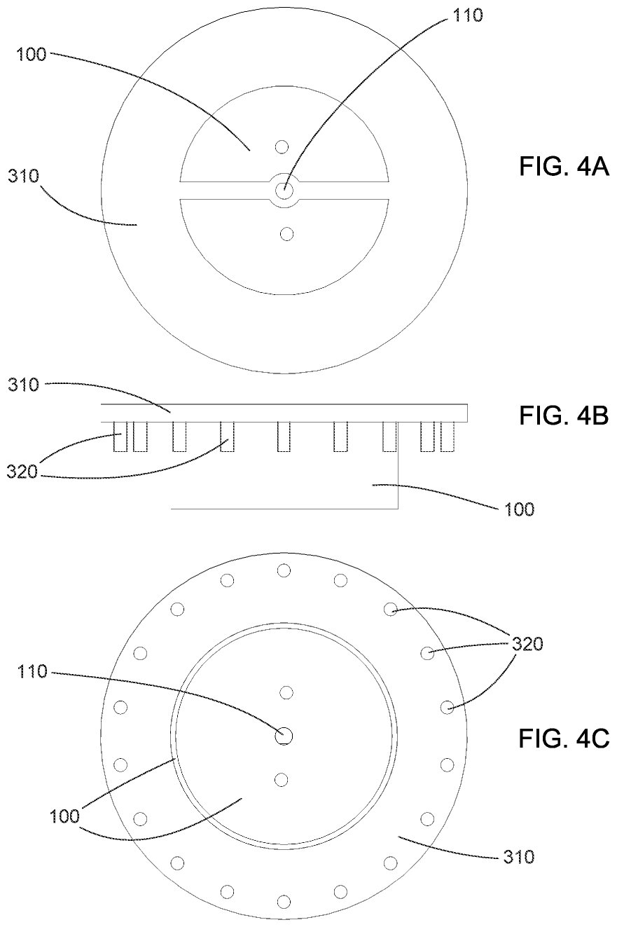

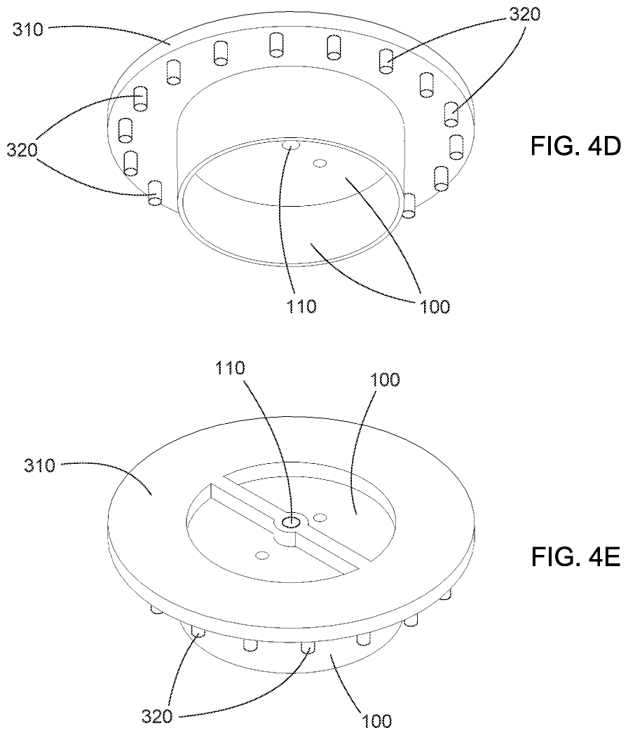

The apparatus is movable between a retracted arrangement and an expanded arrangement; the apparatus can assume arrangements between those extremes. An actuator mechanism (one example illustrated schematically in FIGS. 4A-4E) can be operatively coupled to the hub 100 and the panels 200 so as to move the apparatus between the retracted and expanded arrangements. In the example of FIGS. 1A-1D, the panels 200 are arranged in the expanded arrangement in FIGS. 1A-1C, and relatively closer to the retracted arrangement in FIG. 1D. The length of the proximal portion of each panel 100 that is wound around the hub 100 varies between a maximum wound length in the retracted arrangement and a minimum wound length in the expanded arrangement. Accordingly, an apparatus outer diameter D_{A} across the hub 100 and panels 200 can vary between a minimum diameter D_{R} in the retracted arrangement and a maximum diameter D_{E} in the expanded arrangement; D_{A} can assume values between those extremes.

Note that while circumference and diameter are used herein to characterize the apparatus, in fact the outer edge or surface of the apparatus is not a circle or cylinder but a non-planar, regular, N-sided polygon. However, the relatively large values of N that are typically employed (e.g., 20 or more, 30 or more, or 40 or more) the difference is negligible, and the outer edge or surface of the apparatus can be characterized as if it were circular or cylindrical. Note also that the connected panels 200 can exhibit a handedness; only one handedness is shown in the examples. The present disclosure and appended claims shall encompass both right- and left-handedness (which designations can be arbitrary in some instances).

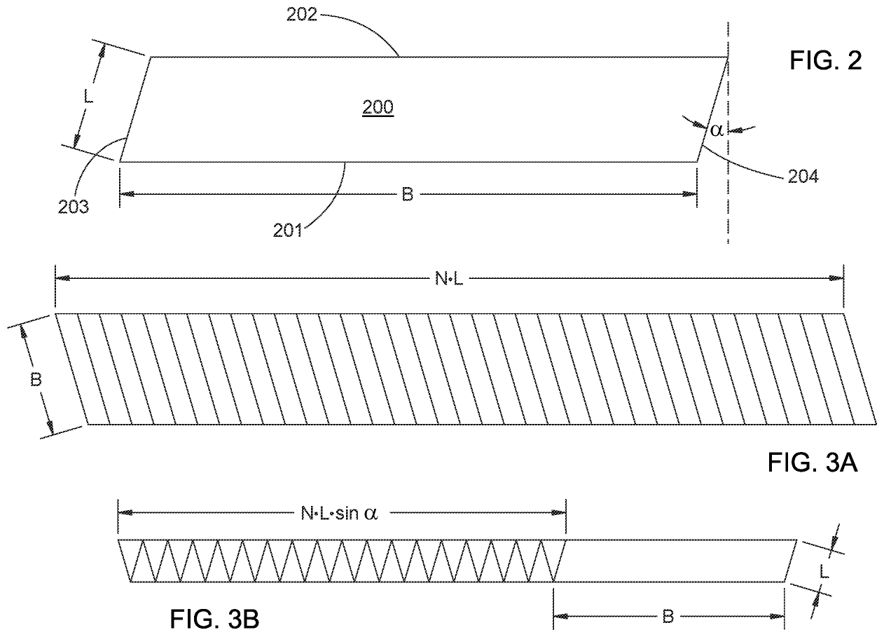

The size, shape, and number of panels 200, and the diameter of the hub 100, cannot all be arbitrarily chosen; parametric constraints exist among them. The number of panels must be an even integer N. In examples wherein the panels 200 are parallelograms, the proximal sides 203 of the panels 200 form an inner triangle-wave pattern around the outer circumferential surface of the hub 100 (visible in FIG. 1A with the hub 100 absent; also visible in FIG. 3B), while the distal sides 204 of the panels 200 form an outer triangle-wave pattern around an outer circumference of the apparatus. The inner triangle-wave pattern has N/2 spatial periods of period length 2·L·sin α; the outer triangle-wave pattern has N/2 spatial periods of period length 2·L·sin θ with α<θ<90°. With the apparatus in the retracted arrangement, θ=θ_{R}, and with the apparatus in the expanded arrangement, θ=θ_{E}>θ_{R}. The hub outer diameter D_{H} is about equal to but not greater than (N·L·sin α)/π. Equality would only be achieved using idealized panels 200 having zero thickness. In reality D_{H} would be slightly less than (N·L·sin α)/η due to the non-zero thickness of the real panels 200; how much smaller depends on the thickness and stiffness of the panels 200. Similarly, the minimum apparatus outer diameter D_{R} is greater than (N·L·sin α)/π, which would correspond to fully winding the panels 200 around the hub 100. The size of the difference can vary depending on the stiffness and non-zero thickness of the panels 200, and also in some instances the specific arrangement of the actuator mechanism, any or all of which can in some instances obstruct full retraction of the panels 200. The maximum apparatus outer diameter D_{E} is less than 2·(B²+(D_{H}/2)²)^{1/2}, which corresponds to the panels 200 fully unwinding from the hub 200. In real examples the stiffness of the panels 200 or details of their attachment to the hub 100 prevent the panels 200 from fully unwinding from the hub 100, so that the apparatus outer diameter does not reach 2·(B²+(D_{H}/2)²)^{1/2}. With the apparatus in the expanded arrangement, length of the distal portion of each panel 200 that extends tangentially from the hub 100 is less than is less than (N·L·cos α)/(2π), because the apparatus outer diameter cannot exceed N·L/π.

Subject to the constraints described above, any suitable set of parameters can be employed. In a first example, N=36, B=5.5 inches, L=1.0 inches, D_{H}=3.25 inches, and α=16.5°; a prototype constructed with those parameters and using a Teflon® sheet for the panels 200 exhibited D_{R}=6 inches and D_{E}=10.5 inches. In a second example, N=40, B=7 inches, L=1.2 inches, D_{H}=2.0 inches, and α=7.5°; a prototype constructed with those parameters and using stiff paper for the panels 200 exhibited D_{R}=6.5 inches and D_{E}=13.5 inches.

The actuator mechanism can be of any suitable type or arrangement. In some examples, the actuator mechanism can be structurally arranged so that (i) during operation to move the panels 200 toward the extended arrangement, one or more of the panels 200 are directly urged to at least partly unwind from around the hub 100, or (ii) during operation to move the panels 200 toward the retracted arrangement, one or more of the panels 200 are directly urged to at least partly wind around the hub 100. In some examples the actuator mechanism can directly urge both winding and unwinding of the panels 200. In some other examples the actuator mechanism can directly urge the panels 200 to either wind or unwind (but not both), and an elastic force restoring the panel 200 to its rest shape urges the panels 200 to either unwind or wind (in the direction opposite the urging of the actuator mechanism).

In some examples (e.g., as in FIGS. 4A-4E), the actuator mechanism includes an actuator member 310 connected to the hub 100 and rotatable relative to the hub 100 about a hub axis (e.g., axle 110 in the example shown). The actuator member 310 includes one or more projections 320 that each extend between a corresponding pair of adjacent panels 200. Rotation of the actuator member 310 (relative to the hub 100) in one direction can urge each projection 320 against a first panel 200 of the corresponding pair, and can directly urge that first panel to at least partly unwind from around the hub 100. Relative rotation of the actuator member in the other direction can urge each projection 320 against the other panel 200 of the corresponding pair, and can directly urge that panel 200 to at least partly wind around the hub 100. As noted above, in various examples the projections 320 can directly urge the panels 200 to both wind and unwind (depending on the direction of movement), while in some examples the projections 320 only directly urge the panels 200 to either wind or unwind, but not both.

In some examples the actuator member includes N/2 projections, with one of those projections positioned between every pair of panels 200 (i.e., so every panel 200 has an adjacent projection 320). In some of those latter examples, a first subset that includes every other panel 200 can be directly urged by a corresponding projection 320 to wind around the hub 100 during movement toward the retracted arrangement; winding of those panels 200 urges the other panels 200 (i.e., a second subset) to wind around the hub 100 as well. During movement in the other direction toward the expanded arrangement, the projections 320 can directly urge the panels 200 of the second subset to unwind from the hub 100; unwinding the panels 200 of the second subsets urges the panels 200 of the first subset to unwind from the hub 100 as well.

In some examples the actuator mechanism can include one or more gears, levers, or cranks arranged for operating the actuator mechanism. In some examples apparatus can include a handle rigidly connected to the hub 100.

The panels 200 can be formed or constructed in any suitable way using any one or more suitable materials. The panels 200 are deformable, meaning that they are solid and can maintain a shape, but can be deformed (typically elastically or with hysteresis) to assume a different shape. For example, each panel 200 must deform as it is wound around the hub 100 to assume the curvature of the hub's outer circumference, but must straighten out as it unwinds from around the hub 100. Each panel 200 must also twist so that its proximal portion can be oriented roughly vertically against the outer circumference of the hub 100 but the distal side 204 can be oriented at the angle θ.

In some examples the panels can be formed from one or more continuous sheets of deformable panel material each in an accordion-fold arrangement (e.g., as in FIGS. 3A and 3B). Each panel 200 would then comprise a single corresponding unfolded area of the sheet, and would be foldably connected to adjacent panels 200 at folds in the corresponding sheet, or to an adjacent panel 200 of another sheet. In some examples all panels 200 can be thus formed from a single continuous sheet of panel material in an accordion-fold arrangement with the opposite end panels connected together. The triangle-wave pattern formed by the proximal ends 203 of the panels 200 is clearly visible in FIG. 3B, which shows the single, continuous sheet of FIG. 3A after it is accordion-folded and laid out flat, before being pulled around to form the closed ring. In some of those folded examples, each fold can be located along a corresponding groove formed in the sheet to facilitate folding along a specified line.

In some examples each panel 200 can be formed as a discrete area of panel material that is foldably connected to adjacent panels 200 by a joint material different from the panel material. In some examples the joint material can be arranged as a corresponding discrete band or strip at each foldable connection between adjacent panels 200, e.g., on or between the adjoining edges of adjacent panels 200. In some examples the joint material can continuously span or cover multiple panels 200 or all or the panels 200, e.g., by overmolding the joint material onto the panels 200 or by embedding the panels 200 within the joint material. In some examples having different panel and join materials, the joint material can be more flexible or more compliant that the panel material. In some examples the joint material can include one or more materials among: one or more papers, cardboards, or fiber boards; one or more metals or alloys, one or more polymers, plastics, or resins (e.g., one or more silicones or one or more elastomers); or one or more composite materials.

In some examples each panel 200 can be a sheet of deformable material or a portion of a sheet of deformable material. In some other examples each panel 200 can comprises a peripheral frame of deformable material and a sheet of flexible material supported by the peripheral frame. In such examples the sheet material can include one or more materials among: one or more papers, cardboards, or fiber boards; one or more woven or matted, natural or synthetic, textile fabrics; one or more metals or alloys; one or more polymers, plastics, or resins; or one or more composite materials.

In some examples the deformable material can include one or more materials among: one or more papers, cardboards, or fiber boards; one or more metals or alloys; one or more polymers, plastics, or resins; or one or more composite materials. In some examples the hub can include one or more materials among: one or more papers, cardboards, or fiber boards; one or more metals or alloys; one or more polymers, plastics, or resins; or one or more composite materials.

To act, e.g., as a lid or seal, in some examples the apparatus can include a sheet of flexible, elastic material forming a closed ring. The ring can be positioned around the outer circumference of the apparatus. In use, the elastic material can be held between the outer circumference of the apparatus and the inner circumference of, e.g., an opening, passage or duct, so that the apparatus can at least partly seal against one or those structures. In some examples the apparatus can include a sheet of flexible, elastic material stretched across one side of the hub 100 and panels 200 and around an outer circumference of the apparatus. The outer edges of such a sheet can act as described above around the apparatus circumference, while the central portion of the sheet can protect the panels 200, hub 100, or actuator mechanism from whatever material is being blocked or contained by the deployed apparatus.

The hub 100 and panels 200 can be formed or assembled together in any suitable way. In some examples, a method for making an inventive apparatus (including any of the examples described herein) can comprise (i) integrally forming the hub 100 and the plurality of panels 200 (e.g., by additive manufacturing), and (ii) coupling the actuator mechanism (if present) to the hub 100 and panels 200. In some examples, a method for making an inventive apparatus (including any of the examples described herein) can comprise (i) folding one or more sheets to form the plurality of panels 200, (ii) attaching the panels 200 to the hub 100, and (iii) coupling the actuator mechanism (if present) to the hub 100 and panels 200. In some examples a method for making an inventive apparatus (including any of the examples described herein) can comprise (i) connecting together the plurality of panels 200, (ii) attaching the panels 200 to the hub 100, and (iii) coupling the actuator mechanism (if present) to the hub 100 and panels 200.

An inventive apparatus, including any of the examples disclosed herein, can be employed in a variety of ways. In some examples, the apparatus can be moved to an intermediate arrangement between the retracted arrangement and the extended arrangement, so that an apparatus outer diameter D_{A} matches a diameter of a lid for a specified container. With the apparatus outer diameter D_{A} matching the diameter of the lid, the apparatus can then be used as a lid for the specified container. In some examples, the inventive apparatus can serve as an adjustable-size lid for a set of pots and/or pans of different sizes.

In some examples, with the apparatus in a first intermediate arrangement having an outer diameter D_{A} that is less than that of a specified opening, passage, or duct, the apparatus can be inserted the apparatus into the opening, passage, or duct. Once in place, the apparatus can be moved toward the expanded arrangement until the outer circumference engages the opening, passage, or duct. In some examples, with the outer circumference thus engaged, the apparatus can occlude the opening, passage, or duct and act as an adjustable-size seal, block, or plug for the opening, passage, or duct, to block, e.g., air or gas flow, liquid flow, weather, light, sound, and so on. In some examples, with the outer circumference thus engaged, the apparatus can act as a centering or alignment jig, with the axis defined by the hub (e.g., defined by the axle 110 or similar structure) being centered within the opening, passage, or duct. When used as a jig, in some examples the hub 100 or axle 110 can include a centered hole or orifice to allow sighting along the axis (e.g., by eye or using a laser alignment beam) or insertion of other centering or alignment hardware (e.g., a string or wire or pin).

In some examples, the apparatus can function as a radial spring. If the resting shape of the panels 200 corresponds to, e.g., an unwound arrangement with D_{A}=D_{E}, then the apparatus would exert a spring force radially outward (i.e., pushing outward) when D_{A} is less than D_{E}. If the resting shape of the panels 200 corresponds to, e.g., a wound arrangement with D_{A}=D_{R}, then the apparatus would exert a spring force radially inward (i.e., pulling inward) when D_{A} is greater than D_{R}. In order to apply a radially inward spring force, one or more of the panels 200 would need to be attached to another structure or object to pull it inward. If the resting shape of the panels 200 corresponds to an intermediate apparatus diameter D_{A}, then the apparatus would exert little or no radial spring force at that diameter, radially outward spring force at smaller apparatus diameters, and radially inward spring force at larger apparatus diameters.

In addition to the preceding, the following example embodiments fall within the scope of the present disclosure or appended claims:

Example 1. An apparatus comprising: (a) a round hub characterized by a hub outer diameter D_{H}; and (b) a plurality of thin, flat, deformable panels, each panel having the shape of a trapezoid with a base, a top parallel to the base, a proximal side, and a distal side, the panels being foldably connected together base-to-top to form a closed ring, a proximal end portion of each panel being attached to an outer circumferential surface of the hub, a proximal portion of each panel being wound around the hub and a distal portion of each panel extending tangentially away from the hub, (c) the apparatus being movable between a retracted arrangement and an expanded arrangement through intermediate arrangements therebetween, length of the proximal portion of each panel that is wound around the hub varying between a maximum wound length in the retracted arrangement and a minimum wound length in the expanded arrangement, so that an apparatus outer diameter D_{A} across the hub and panels can vary from a minimum diameter D_{R} in the retracted arrangement through intermediate diameters to a maximum diameter D_{E} in the expanded arrangement.

Example 2. The apparatus of Example 1 wherein: (i) the number of panels is an even integer N; (ii) each panel has the shape of a parallelogram with a base and a top of length B, proximal and distal sides of length L, and interior angles of 90°±α with 0°<α<90°; (iii) the proximal sides of the panels form an inner triangle-wave pattern around the outer circumferential surface of the hub, and the inner triangle-wave pattern has N/2 spatial periods of period length 2·L·sin α around the outer circumferential surface of the hub; (iv) the distal sides of the panels form an outer triangle-wave pattern around an outer circumference of the apparatus, and the outer triangle-wave pattern has N/2 spatial periods of period length 2·L·sin θ around the outer circumference of the apparatus with α<θ<90°; (v) with the apparatus in the retracted arrangement, θ=θ_{R}, and with the apparatus in the expanded arrangement, θ=θ_{E}>θ_{R}; (vi) the hub outer diameter D_{H} is about equal to but not greater than (N·L·sin α)/π, D_{R} is greater than (N·L·sin α)/π, and D_{E} is less than 2·(B²+(D_{H}/2)²)^{1/2} and less than N·L/π; and (vii) with the apparatus in the expanded arrangement, length of the distal portion of each panel that extends tangentially from the hub is less than (N·L·cos α)/(2π).

Example 3. The apparatus of any one of Examples 1 or 2, further comprising an actuator mechanism operatively coupled to the hub and the panels so as to move the apparatus between the retracted arrangement and the expanded arrangement through intermediate arrangements therebetween.

Example 4. The apparatus of Example 3, the actuator mechanism being structurally arranged so that (i) during operation to move the panels toward the extended arrangement, one or more of the panels are directly urged to at least partly unwind from around the hub, or (ii) during operation to move the panels toward the retracted arrangement, one or more of the panels are directly urged to at least partly wind around the hub.

Example 5. The apparatus of Example 4, the actuator mechanism including an actuator member connected to the hub and rotatable relative to the hub about a hub axis, the actuator member including one or more projections each extending between a corresponding pair of adjacent panels so that (i) relative rotation of the actuator member in a first direction urges each projection against a first panel of the corresponding pair to directly urge that first panel to at least partly unwind from around the hub, or (ii) relative rotation of the actuator member in a second direction, opposite the first direction, urges each projection against a second, different panel of the corresponding pair to directly urge that second panel to at least partly wind around the hub.

Example 6. The apparatus of Example 5, the actuator member includes N/2 projections, with every pair of panels having a corresponding projection positioned therebetween.

Example 7. The apparatus of any one of Examples 3 through 6, the actuator mechanism including one or more gears, levers, or cranks arranged for operating the actuator mechanism.

Example 8. The apparatus of any one of Examples 1 through 7, further comprising a handle rigidly connected to the hub.

Example 9. The apparatus of any one of Examples 1 through 8, the panels being formed from one or more continuous sheets of panel material each in an accordion-fold arrangement, so that each panel comprises a single corresponding unfolded area of the sheet and is foldably connected to adjacent panels at folds in the corresponding sheet or to an adjacent panel of another sheet.

Example 10. The apparatus of any one of Examples 1 through 9, the panels being formed from a single continuous sheet of panel material in an accordion-fold arrangement, so that each panel comprises a single corresponding unfolded area of the sheet and is foldably connected to adjacent panels at folds in the sheet or to a panel at an opposite end of the sheet.

Example 11. The apparatus of any one of Examples 9 or 10, each fold being located along a corresponding groove formed in the sheet.

Example 12. The apparatus of any one of Examples 1 through 8, each panel being formed as a discrete area of panel material and being foldably connected to adjacent panels by a joint material different from the panel material.

Example 13. The apparatus of Example 12, the joint material being arranged as a corresponding discrete band or strip at one or more or all foldable connections between adjacent panels.

Example 14. The apparatus of any one of Examples 12 or 13, the joint material being arranged to continuously span or cover multiple panels or all of the panels.

Example 15. The apparatus of any one of Examples 12 through 14, the joint material being more flexible or more compliant than the panel material.

Example 16. The apparatus of any one of Examples 12 through 15, the joint material including one or more materials among: one or more papers, cardboards, or fiber boards; one or more metals or alloys, one or more polymers, plastics, or resins; or one or more composite materials.

Example 17. The apparatus of any one of Examples 1 through 16, each panel being a sheet of deformable material or a portion of a sheet of deformable material.

Example 18. The apparatus of any one of Examples 1 through 16, each panel comprising a peripheral frame of deformable material and a sheet of flexible material supported by the peripheral frame.

Example 19. The apparatus of Example 18, the flexible sheet material including one or more materials among: one or more papers, cardboards, or fiber boards; one or more woven or matted, natural or synthetic, textile fabrics; one or more metals or alloys; one or more polymers, plastics, or resins; or one or more composite materials.

Example 20. The apparatus of any one of Examples 17 through 19, the deformable material including one or more materials among: one or more papers, cardboards, or fiber boards; one or more metals or alloys; one or more polymers, plastics, or resins; or one or more composite materials.

Example 21. The apparatus of any one of Examples 1 through 20, the hub including one or more materials among: one or more papers, cardboards, or fiber boards; one or more metals or alloys; one or more polymers, plastics, or resins; or one or more composite materials.

Example 22. The apparatus of any one of Examples 1 through 21, further comprising a sheet of flexible, elastic material forming a closed ring positioned around an outer circumference of the apparatus.

Example 23. The apparatus of any one of Examples 1 through 22, further comprising a sheet of flexible, elastic material stretched across one side of the hub and panels and around an outer circumference of the apparatus.

Example 24. The apparatus of any one of Examples 1 through 23, wherein N=36, B=5.5 inches, L=1.0 inches, D_{H}=3.25 inches, and α=16.5°.

Example 25. The apparatus of any one of Examples 1 through 23, wherein N=40, B=7 inches, L=1.2 inches, D_{H}=2.0 inches, and α=7.5°.

Example 26. A method for making the apparatus of any one of Examples 1 through 25, the method comprising integrally forming the hub and the plurality of panels.

Example 27. A method for making the apparatus of any one of Examples 1 through 25, the method comprising (i) folding one or more sheets to form the plurality of panels, and (ii) attaching the panels to the hub.

Example 28. A method for making the apparatus of any one of Examples 1 through 25, the method comprising (i) connecting together the plurality of panels, and (ii) attaching the panels to the hub.

Example 29. The method of any one of claims 26 through 28, further comprising coupling an actuator mechanism to the hub and panels.

Example 30. A method for using the apparatus of any one of Examples 1 through 25, the method comprising: (i) moving the apparatus to an intermediate arrangement between the retracted arrangement and the extended arrangement, so that an apparatus outer diameter in the intermediate arrangement matches a diameter of a lid or cover for a specified container; and (ii) with the apparatus outer diameter matching the diameter of the lid or cover, using the apparatus as a lid or cover for the specified container.

Example 31. A method for using the apparatus of any one of Examples 1 through 25, the method comprising: (i) with the apparatus in a first intermediate arrangement having a first apparatus outer diameter that is less than that of a specified opening, passage, or duct, inserting the apparatus into the opening, passage, or duct; and (ii) moving the apparatus toward the expanded arrangement until the outer circumference engages the opening, passage, or duct so that the apparatus occludes the opening, passage, or duct.

Example 32. A method for using the apparatus of any one of Examples 1 through 25, the method comprising: (i) with the apparatus in a first intermediate arrangement having a first apparatus outer diameter that is less than that of a specified opening, passage, or duct, inserting the apparatus into the opening, passage, or duct; and (ii) moving the apparatus toward the expanded arrangement until the outer circumference engages the opening, passage, or duct so that an axis defined by the hub is centered within the opening, passage, or duct.

Example 33. A method for using the apparatus of any one of Examples 1 through 25, the method comprising positioning the apparatus relative to one or more other objects so that the apparatus exerts a radial spring force on the one or more other objects.

This disclosure is illustrative and not limiting. Further modifications will be apparent to one skilled in the art in light of this disclosure and are intended to fall within the scope of the present disclosure or appended claims. It is intended that equivalents of the disclosed example embodiments and methods, or modifications thereof, shall fall within the scope of the present disclosure or appended claims.

In the foregoing Detailed Description, various features may be grouped together in several example embodiments for the purpose of streamlining the disclosure. This method of disclosure is not to be interpreted as reflecting an intention that any claimed embodiment requires more features than are expressly recited in the corresponding claim. Rather, as the appended claims reflect, inventive subject matter may lie in less than all features of a single disclosed example embodiment. Therefore, the present disclosure shall be construed as implicitly disclosing any embodiment having any suitable subset of one or more features—which features are shown, described, or claimed in the present application—including those subsets that may not be explicitly disclosed herein. A “suitable” subset of features includes only features that are neither incompatible nor mutually exclusive with respect to any other feature of that subset. Accordingly, the appended claims are hereby incorporated in their entirety into the Detailed Description, with each claim standing on its own as a separate disclosed embodiment. In addition, each of the appended dependent claims shall be interpreted, only for purposes of disclosure by said incorporation of the claims into the Detailed Description, as if written in multiple dependent form and dependent upon all preceding claims with which it is not inconsistent. It should be further noted that the cumulative scope of the appended claims can, but does not necessarily, encompass the whole of the subject matter disclosed in the present application.

The following interpretations shall apply for purposes of the present disclosure and appended claims. The words “comprising,” “including,” “having,” and variants thereof, wherever they appear, shall be construed as open ended terminology, with the same meaning as if a phrase such as “at least” were appended after each instance thereof, unless explicitly stated otherwise. The article “a” shall be interpreted as “one or more” unless “only one,” “a single,” or other similar limitation is stated explicitly or is implicit in the particular context; similarly, the article “the” shall be interpreted as “one or more of the” unless “only one of the,” “a single one of the,” or other similar limitation is stated explicitly or is implicit in the particular context. The conjunction “or” is to be construed inclusively unless: (i) it is explicitly stated otherwise, e.g., by use of “either . . . or,” “only one of,” or similar language; or (ii) two or more of the listed alternatives are understood or disclosed (implicitly or explicitly) to be incompatible or mutually exclusive within the particular context. In that latter case, “or” would be understood to encompass only those combinations involving non-mutually-exclusive alternatives. In one example, each of “a dog or a cat,” “one or more of a dog or a cat,” and “one or more dogs or cats” would be interpreted as one or more dogs without any cats, or one or more cats without any dogs, or one or more of each. In another example, each of “a dog, a cat, or a mouse,” “one or more of a dog, a cat, or a mouse,” and “one or more dogs, cats, or mice” would be interpreted as (i) one or more dogs without any cats or mice, (ii) one or more cats without and dogs or mice, (iii) one or more mice without any dogs or cats, (iv) one or more dogs and one or more cats without any mice, (v) one or more dogs and one or more mice without any cats, (vi) one or more cats and one or more mice without any dogs, or (vii) one or more dogs, one or more cats, and one or more mice. In another example, each of “two or more of a dog, a cat, or a mouse” or “two or more dogs, cats, or mice” would be interpreted as (i) one or more dogs and one or more cats without any mice, (ii) one or more dogs and one or more mice without any cats, (iii) one or more cats and one or more mice without and dogs, or (iv) one or more dogs, one or more cats, and one or more mice; “three or more,” “four or more,” and so on would be analogously interpreted.

For purposes of the present disclosure or appended claims, when a numerical quantity is recited (with or without terms such as “about,” “about equal to,” “substantially equal to,” “greater than about,” “less than about,” and so forth), standard conventions pertaining to measurement precision, rounding error, and significant digits shall apply, unless a differing interpretation is explicitly set forth. For null quantities described by phrases such as “substantially prevented,” “substantially absent,” “substantially eliminated,” “about equal to zero,” “negligible,” and so forth, each such phrase shall denote the case wherein the quantity in question has been reduced or diminished to such an extent that, for practical purposes in the context of the intended operation or use of the disclosed or claimed apparatus or method, the overall behavior or performance of the apparatus or method does not differ from that which would have occurred had the null quantity in fact been completely removed, exactly equal to zero, or otherwise exactly nulled.

For purposes of the present disclosure and appended claims, any labelling of elements, steps, limitations, or other portions of an embodiment, example, or claim (e.g., first, second, third, etc., (a), (b), (c), etc., or (i), (ii), (iii), etc.) is only for purposes of clarity, and shall not be construed as implying any sort of ordering or precedence of the portions so labelled. If any such ordering or precedence is intended, it will be explicitly recited in the embodiment, example, or claim or, in some instances, it will be implicit or inherent based on the specific content of the embodiment, example, or claim. In the appended claims, if the provisions of 35 USC § 112(f) are desired to be invoked in an apparatus claim, then the word “means” will appear in that apparatus claim. If those provisions are desired to be invoked in a method claim, the words “a step for” will appear in that method claim. Conversely, if the words “means” or “a step for” do not appear in a claim, then the provisions of 35 USC § 112(f) are not intended to be invoked for that claim.

If any one or more disclosures are incorporated herein by reference and such incorporated disclosures conflict in part or whole with, or differ in scope from, the present disclosure, then to the extent of conflict, broader disclosure, or broader definition of terms, the present disclosure controls. If such incorporated disclosures conflict in part or whole with one another, then to the extent of conflict, the later-dated disclosure controls.

The Abstract is provided as required as an aid to those searching for specific subject matter within the patent literature. However, the Abstract is not intended to imply that any elements, features, or limitations recited therein are necessarily encompassed by any particular claim. The scope of subject matter encompassed by each claim shall be determined by the recitation of only that claim.

What is claimed is:

1. An apparatus comprising:
(a) a round hub characterized by a hub outer diameter D_{H}; and
(b) a plurality of thin, flat, deformable panels, each panel having the shape of a trapezoid with a base, a top parallel to the base, a proximal side, and a distal side, the panels being foldably connected together base-to-top to form a closed ring, a proximal end portion of each panel being attached to an outer circumferential surface of the hub, a proximal portion of each panel being wound around the hub and a distal portion of each panel extending tangentially away from the hub,
(c) the apparatus being movable between a retracted arrangement and an expanded arrangement through intermediate arrangements therebetween, length of the proximal portion of each panel that is wound around the hub varying between a maximum wound length in the retracted arrangement and a minimum wound length in the expanded arrangement, so that an apparatus outer diameter D_{A} across the hub and panels can vary from a minimum diameter D_{R} in the retracted arrangement through intermediate diameters to a maximum diameter D_{E} in the expanded arrangement.

2. The apparatus of claim 1 wherein:
(i) the number of panels is an even integer N;
(ii) each panel has the shape of a parallelogram with a base and a top of length B, proximal and distal sides of length L, and interior angles of 90°±α with 0°<α<90°;
(iii) the proximal sides of the panels form an inner triangle-wave pattern around the outer circumferential surface of the hub, and the inner triangle-wave pattern has N/2 spatial periods of period length 2·L·sin α around the outer circumferential surface of the hub;
(iv) the distal sides of the panels form an outer triangle-wave pattern around an outer circumference of the apparatus, and the outer triangle-wave pattern has N/2 spatial periods of period length 2·L·sin θ around the outer circumference of the apparatus with α<θ<90°;
(v) with the apparatus in the retracted arrangement, θ=θ_{R}, and with the apparatus in the expanded arrangement, θ=θ_{E}>θ_{R};
(vi) the hub outer diameter D_{H} is about equal to but not greater than (N·L·sin α)/π, D_{R} is greater than (N·L·sin α)/π, and D_{E} is less than 2·(B²+(D_{H}/2)²)^{1/2} and less than N·L/π; and
(vii) with the apparatus in the expanded arrangement, length of the distal portion of each panel that extends tangentially from the hub is less than (N·L·cos α)/(2π).

3. The apparatus of claim 1, further comprising an actuator mechanism operatively coupled to the hub and the panels so as to move the apparatus between the retracted arrangement and the expanded arrangement through intermediate arrangements therebetween.

4. The apparatus of claim 3, the actuator mechanism being structurally arranged so that (i) during operation to move the panels toward the extended arrangement, one or more of the panels are directly urged to at least partly unwind from around the hub, or (ii) during operation to move the panels toward the retracted arrangement, one or more of the panels are directly urged to at least partly wind around the hub.

5. The apparatus of claim 4, the actuator mechanism including an actuator member connected to the hub and rotatable relative to the hub about a hub axis, the actuator member including one or more projections each extending between a corresponding pair of adjacent panels so that (i) relative rotation of the actuator member in a first direction urges each projection against a first panel of the corresponding pair to directly urge that first panel to at least partly unwind from around the hub, or (ii) relative rotation of the actuator member in a second direction, opposite the first direction, urges each projection against a second, different panel of the corresponding pair to directly urge that second panel to at least partly wind around the hub.

6. The apparatus of claim 5, the actuator member includes N/2 projections, with every pair of panels having a corresponding projection positioned therebetween.

7. The apparatus of claim 1, the panels being formed from one or more continuous sheets of panel material each in an accordion-fold arrangement, so that each panel comprises a single corresponding unfolded area of the sheet and is foldably connected to adjacent panels at folds in the corresponding sheet or to an adjacent panel of another sheet.

8. The apparatus of claim 7, each fold being located along a corresponding groove formed in the sheet.

9. The apparatus of claim 1, the panels being formed from a single continuous sheet of panel material in an accordion-fold arrangement, so that each panel comprises a single corresponding unfolded area of the sheet and is foldably connected to adjacent panels at folds in the sheet or to a panel at an opposite end of the sheet.

10. The apparatus of claim 1, each panel being formed as a discrete area of panel material and being foldably connected to adjacent panels by a joint material different from the panel material.

11. The apparatus of claim 10, the joint material being arranged as a corresponding discrete band or strip at one or more or all foldable connections between adjacent panels.

12. The apparatus of claim 10, the joint material being arranged to continuously span or cover multiple panels or all of the panels.

13. The apparatus of claim 10, the joint material being more flexible or more compliant that the panel material.

14. The apparatus of claim 1, each panel being a sheet of deformable material or a portion of a sheet of deformable material.

15. The apparatus of claim 1, each panel comprising a peripheral frame of deformable material and a sheet of flexible material supported by the peripheral frame.

16. The apparatus of claim 1, further comprising a sheet of flexible, elastic material forming a closed ring positioned around an outer circumference of the apparatus.

17. The apparatus of claim 1, further comprising a sheet of flexible, elastic material stretched across one side of the hub and panels and around an outer circumference of the apparatus.

18. A method for making the apparatus of claim 1, the method comprising integrally forming the hub and the plurality of panels.

19. A method for making the apparatus of claim 1, the method comprising
(i) folding one or more sheets to form the plurality of panels, and (ii) attaching the panels to the hub.

20. A method for making the apparatus of claim 1, the method comprising
(i) connecting together the plurality of panels, and (ii) attaching the panels to the hub.

21. A method for using the apparatus of claim 1, the method comprising:
(i) moving the apparatus to an intermediate arrangement between the retracted arrangement and the extended arrangement, so that an apparatus outer diameter in the intermediate arrangement matches a diameter of a lid or cover for a specified container; and (ii) with the apparatus outer diameter matching the diameter of the lid or cover, using the apparatus as a lid or cover for the specified container.

22. A method for using the apparatus of claim 1, the method comprising: (i) with the apparatus in a first intermediate arrangement having a first apparatus outer diameter that is less than that of a specified opening, passage, or duct, inserting the apparatus into the opening, passage, or duct; and (ii) moving the apparatus toward the expanded arrangement until the outer circumference engages the opening, passage, or duct so that the apparatus occludes the opening, passage, or duct.

23. A method for using the apparatus of claim 1, the method comprising: (i) with the apparatus in a first intermediate arrangement having a first apparatus outer diameter that is less than that of a specified opening, passage, or duct, inserting the apparatus into the opening, passage, or duct; and (ii) moving the apparatus toward the expanded arrangement until the outer circumference engages the opening, passage, or duct so that an axis defined by the hub is centered within the opening, passage, or duct.

24. A method for using the apparatus of claim 1, the method comprising positioning the apparatus relative to one or more other objects so that the apparatus exerts a radial spring force on the one or more other objects.
